(19) United States
(12) Patent Application Publication
(10) Pub. No.: US 2007/0266170 A1
(43) Pub. Date: Nov. 15, 2007

(54) INTERACTIVE, RICH-MEDIA DELIVERY OVER AN IP NETWORK USING SYNCHRONIZED UNICAST AND MULTICAST

(76) Inventor: Gregory P. Mockett, Spanish Fork, UT (US)

Correspondence Address: Kunzler & McKenzie, 8 EAST BROADWAY, SUITE 600, SALT LAKE CITY, UT, 84111, US

(21) Appl. No.: 11/747,205

(22) Filed: May 10, 2007

Related U.S. Application Data
(63) Continuation-in-part of application No. 11/432,776, filed on May 11, 2006.
(60) Provisional application No. 60/799,729, filed on May 11, 2006.

(51) Int. Cl. G06F 15/16

(52) U.S. Cl. 709/231

(57) ABSTRACT

An apparatus, system, and method are disclosed for delivering rich media over a digital network. The invention includes processing rich media in two or more sub-streams. The rich media includes video content or audio content. The sub-streams include digital packets for transport over IP networks. The invention includes adding synchronizing information to the sub-streams by adding sequencing information to the digital packets of each sub-stream, where digital packets of the sub-streams that correspond to a point in play each include a sequence identifier indicating the point in play. The synchronizing information is sufficient for a client to combine the sub-streams to form the rich media. The invention includes transmitting the sub-streams concurrently over one or more digital networks to the client for combining the sub-streams to form the rich media. Each of the sub-streams is transmitted over a different route. Each route corresponds to a unique sub-stream address.

### CROSS-REFERENCES TO RELATED APPLICATIONS

This application is a continuation-in-part of and claims priority to U.S. Provisional Patent Application No. 60/799,729 and U.S. patent application Ser. No. 11/432,776 both entitled “Interactive, Rich-Media, Delivery Over IP Network Using Synchronized Unicast and Multicast” and both filed on May 11, 2006 for Gregory P. Mockett, which are incorporated herein by reference.

### BACKGROUND OF THE INVENTION

1. Field of the Invention

This invention relates to delivery of rich media over an Internet Protocol (“IP”) network and more particularly relates to delivery of rich media using a synchronized unicast and multicast.

2. Description of the Related Art

When delivering “rich media” (e.g. audio, video, and the like) over an IP network, several challenges are encountered. For example, cost of bandwidth is too high for publishers of on-demand or streaming video, as all video streams must be provided in a 1:1 ratio with the viewers. Accordingly, if it costs $4 for each concurrent stream, an audience of 1,000,000 concurrent viewers requires $4,000,000. A web site serving pages to the same number of concurrent users may cost $4,000. Additionally, standard definition television delivered over the web at full screen size may incur costs as high as $15 per concurrent stream, or $15,000,000. This forces a compromise that leads to two inch by three inch play windows, poor audio synchronization, low frame rates, low resolution, limited selection, truncation, and other cost-cutting measures.

Perhaps the most glaring challenge, however, is that of scale at the edges of the internet. A broadband ISP, for example, might have a 100 Mbps network serving a 500 customers in a neighborhood network. If unicast video is accessed by just 20% of his customers, and the average video is a 1 Mbps stream, then the network is completely saturated. Whereas during primetime television viewing typical concurrent television audiences would represent 70% to 90% of the homes in a television cable network, for example will be concurrently served. The scale problem means that unicast or 1:1 video delivery cannot work over IP Networks for large concurrent viewing audiences.

Multicast technologies could solve the publisher efficiency and the scale problems by changing the bandwidth cost to a ratio of 1:∞ (one to infinity), which would not only make it cheaper but would actually make the bandwidth costs become increasingly incrementally insignificant. This would allow the publisher or distributor of video properties to send out “heavier” streams that are capable of full screen, high resolution, full frame rate, etc., quality audio/video properties. However, multicasting technologies severely limit or eliminate interactivity, identity, on-demand, and player-control capabilities. Additionally, multicast is a “fire and forget” protocol, meaning that it cannot know who watched what when, nor can it repair itself to assure quality of the video delivered. And because routers control the distribution, not source video servers, there is little a publisher can do to limit the audience for business or privacy purposes.

A further problem with routers controlling the replication and distribution of multicast streams is that in interdomain applications, where a publisher may be hosted on IP Network A and the viewer is no network C and the video must travel across B to get to C, then all opportunities for managing quality control, security, etc. within the hardware/netwok management layer are forfeited as the stream moves across networks uncontrolled by the publisher or the operator of Network A.

If interactive elements are placed into a rich media presentation, then it will need to travel as a unicast to accommodate. This means that the potential benefits of multicasting the video are lost.

Another challenge is that access to rich media content is scattered and poorly organized. Current search-engine and directory structures are highly unlikely to index this exploding population of properties because machine-image and video recognition needed for this task are virtually non-existent. While the human mind is easily capable of categorizing this content accurately and quickly, it requires a concentrated effort to educate reviewers and tabulate and organize their summary reviews. No present system aggregates viewers into a single portal for such a practice. Nor does a suitable authoring system exist to attach metadata to a rich media property.

A further challenge is that current browsers were not written to handle rich media. They were written to read and display markup text files. Accordingly, their ability to display other properties including rich media is a function of Plug-ins that take over that function for the browser. This reader/display motif does not allow the rich media (audio, video, executables for games, and the like) to determine web location(s) and provide the desired interactivity.

While it may be desirable to include web properties (and other types of display/interactivity) directly within the rich media properties, this capability is currently not available. Currently, due to the plug-in patch browser scenario, selecting a web property in a display window where rich media is playing will typically kill the display in favor of a new web display.

Because it is linear rather than on demand, multicast does not natively allow for player controls, such as rewind or fast forward. Additionally, rich media, whether in audio or video, is composited as part of the normal encoding process, that loses quality information and reduces consumer control options.

Furthermore, because value-added interactivity such as message boards, chat rooms, etc. programs are, like rich media, page dependent, site dependent, or both, for their continuity, they isolate the web's social qualities to that host site. If a group of friends located remotely from one another decides to watch a movie together, go shopping online together, or read various sports sites together, or game together, they will be sorely disappointed. Due to the manner in which rich media is currently streamed on demand, there is virtually no way to effectively synchronize the display of a rich media property within the same site for multiple viewers.

### SUMMARY OF THE INVENTION

From the foregoing discussion, it should be apparent that a need exists for an apparatus, system, and method that processes rich media in sub-streams that can be transmitted simultaneously to a client over different routes and creates a transparent interactive overlay with synchronizing information, error correction information, program information, alternate audio or text routes, and other rich media properties. The transparent interactive overlay may be partially or completely sent to the client as an interactive layer using a unicast or other bi-directional communication. Beneficially, such an apparatus, system, and method would provide a way for a client to receive multiple sub-streams and synchronize the sub-streams using information from the interactive layer, such as mapping, sub-stream addressing information, error correction, and synchronizing information. Information such as subtitles, scrambling, advertisement directed specifically to the client, links, etc. may also be received on a sub-stream as a transparent interactive overlay or over the interactive layer.

The present invention has been developed in response to the present state of the art, and in particular, in response to the problems and needs in the art that have not yet been fully solved by currently available IP multicast protocols and standards for implementation into IP networking equipment or by application layer solutions from proprietary rich media player vendors. Accordingly, the present invention has been developed to provide an apparatus, system, and method for rich media delivery over a digital network by various rich media publishers and distributors, and certain broadband access network providers that overcome many or all of the above-discussed shortcomings in the art.

A method of the present invention is also presented for delivering rich media over a digital network. The method in the disclosed embodiments substantially includes the steps necessary to carry out the functions presented above with respect to the operation of the described apparatus and system. In one embodiment, the method includes processing rich media in two or more sub-streams. The rich media includes at least video content or audio content. The two or more sub-streams include digital packets for transport over Internet Protocol (“IP”) networks.

The method also includes adding synchronizing information to the two or more sub-streams by adding sequencing information to the digital packets of each sub-stream, where digital packets of the two or more sub-streams that correspond to a point in play each include a sequence identifier indicating the point in play. The synchronizing information is sufficient for a client to combine the sub-streams to form the rich media. The method includes transmitting the two or more sub-streams concurrently over one or more digital networks to the client for combining the sub-streams to form the rich media, where each of the two or more sub-streams is transmitted over a different route. Each route corresponds to a unique sub-stream address and the client requests transmission of the sub-streams from the unique sub-stream addresses.

In a further embodiment, the method includes creating a transparent interactive overlay corresponding to the rich media and synchronized to one or more sub-streams of the rich media. The transparent interactive overlay, in one embodiment, includes at least one of the synchronizing information, sub-stream address information, markup language data, text data, programming data, error correction data, and mapping data. In another embodiment, at least a portion of the transparent interactive overlay includes an interactive layer that includes one sub-stream of the two or more sub-streams. In another embodiment, the interactive layer is transmitted using a bi-directional unicast. In yet another embodiment, the transparent interactive overlay is combined with one or more of the sub-streams.

In one embodiment, processing rich media in two or more streams includes dividing sub-streams from the rich media or formatting for transmission rich media authored as sub-streams. In another embodiment, the method includes transmitting replacement sub-stream data using an interactive layer to the client in response to the client determining that sub-stream data is missing or is in error. In another embodiment, transmitting replacement sub-stream data also includes transmitting the replacement sub-stream data to an error correction server for use by a client requesting the replacement sub-stream data to correct a sub-stream. In another embodiment, at least one of the sub-streams is transmitted using multicast, a broadcast, or a unicast. In another embodiment, at least two sub-streams include error correction information sufficient to recreate missing or erroneous sub-stream data of a sub-stream.

In one embodiment, a sub-stream includes a composite rich media stream, a component stream, an audio stream, a transparent interactive overlay stream, a text stream, or a markup language stream. In another embodiment, the method includes transmitting sub-streams representing the rich media to two or more clients and transmitting an interactive layer over a bi-directional connection to each of the two or more clients. The embodiment may also include transmitting a customized interactive layer to two or more clients or to each of a group of clients representing a subset of the two or more clients. In another embodiment, the customized interactive layer includes advertising, customized programming, subscription data, encryption information, messages, or client-specific information.

Another method of the present invention is also presented for receiving rich media over a digital network. In one embodiment, the method includes requesting receipt of two or more sub-streams over a digital network. Each sub-stream is requested from a different address. The sub-streams include digital packet data suitable for transport over IP networks and are combined with synchronizing information. The synchronizing information includes sequence information added to the digital packets of each sub-stream, where digital packets of the two or more sub-streams that correspond to a point in play each include a sequence identifier indicating the point in play. The method includes receiving the sub-streams. The method includes combing the sub-streams to form the rich media based on the synchronizing information contained in the sub-streams. The rich media includes video data or audio data.

The method, in one embodiment, includes receiving a transparent interactive overlay as part of one or more sub-streams. The transparent interactive overlay is synchronized to one or more of the sub-streams and corresponds to the rich media from which the sub-streams were processed. In another embodiment, the transparent interactive overlay includes at least one of synchronizing information, sub-stream address information, markup language data, text data, programming data, error correction data, and mapping data. In another embodiment, the method includes receiving an interactive layer via a bi-directional unicast from an address of the digital network different from an address of the one or more other sub-streams. In another embodiment, the interactive layer includes one of the two or more sub-streams. In yet another embodiment, the interactive layer includes the synchronizing information, sub-stream address information, markup language data, text data, programming data, error correction data, or mapping data.

The method, in one embodiment, includes receiving sub-stream replacement data over the interactive layer and combining the sub-stream replacement data with a sub-stream to form a corrected sub-stream in response to detecting that a sub-stream is missing data or has incorrect data. In another embodiment, receiving sub-stream replacement data includes receiving sub-stream replacement data from an error correction server. In another embodiment, receiving the sub-streams includes receiving scrambled sub-streams and includes descrambling the sub-streams prior to combining the sub-streams. In another embodiment, the method includes dynamically receiving one or more encryption or descrambling keys as part of an interactive layer received over a bi-directional connection. The encryption or descrambling keys are used for decrypting or descrambling the sub-streams.

In one embodiment, the method includes storing one or more sub-streams for later playback. In another embodiment, the method includes storing the formed rich media for later playback. In another embodiment, the method includes partially storing one or more sub-streams or the formed rich media while displaying the formed rich media prior to complete receipt of the sub-streams. In another embodiment, the method includes partially storing one or more sub-streams for sequenced combination with other sub-streams. In yet another embodiment, the method includes and playing the formed rich media.

A system of the present invention is also presented to receive rich media over a digital network. The system may be embodied by a digital network and a client in communication with the digital network. The client includes a request module that requests receipt of two or more sub-streams over the digital network. Each sub-stream is requested from a different address. The sub-streams include digital packet data suitable for transport over IP networks and are combined with synchronizing information. The synchronizing information includes sequence information added to the digital packets of each sub-stream. Digital packets of the two or more sub-streams that correspond to a point in play each include a sequence identifier indicating the point in play. The client includes a receiver module that receives the sub-streams. The client includes a combining module that combines the sub-streams to form the rich media based on the synchronizing information contained in the sub-streams. The rich media includes video data or audio data.

In one embodiment, the system includes an interactive layer module that receives an interactive layer. The interactive layer is synchronized to one or more of the sub-streams and corresponds to the rich media from which the sub-streams were processed. In another embodiment, the interactive layer module is further configured to receive replacement sub-stream data and to combine the replacement sub-stream data with a sub-stream to form a corrected sub-stream in response to detecting that a sub-stream is missing data or has incorrect data. In another embodiment, the system includes an error correction module that corrects a sub-stream error using error correction data from a sub-stream. In another embodiment, the digital network includes an IP network, a satellite broadcast system, an over-the-air broadcast system, a local area network, a wide area network, a wireless network, or a storage area network.

In one embodiment, the client may include at least one of a personal computer, a laptop computer, a server, a workstation, a gaming platform, a television, a set-top box, a satellite receiver, a projection system, a Digital Video Disc (“DVD”) player, a video cassette recorder, a video cassette player, a portable audio or video player, a video conferencing system, an audio or video phone, an appliance, and a portable communication device.

Another system of the present invention is also presented to receive rich media over a digital network. The system may be embodied by a digital network and a source computer system in communication with the digital network. The source computer system includes a processing module that processes rich media in two or more sub-streams. The rich media includes video content or audio content. The two or more sub-streams include digital packets for transport over IP networks.

The source computer system includes a synchronizing module that adds synchronizing information to the two or more sub-streams by adding sequence information to the digital packets of each sub-stream. Digital packets of the two or more sub-streams that correspond to a point in play each include a sequence identifier indicating the point in play. The synchronizing information is sufficient for a client to combine the sub-streams to form the rich media.

The source computer system includes a transmission module that transmits the two or more sub-streams concurrently over one or more digital networks to the client for combining the sub-streams to form the rich media. Each of the two or more sub-streams is transmitted over a different route. Each route corresponds to a unique sub-stream address and the client requests transmission of the sub-streams from the unique sub-stream addresses.

The system, in one embodiment, includes an interactive overlay module that creates a transparent interactive overlay corresponding to the rich media and synchronized to one or more sub-streams of the rich media. In a further embodiment, the system includes an interactive layer transmission module that transmits an interactive layer to the client. The interactive layer includes at least one of sub-stream address information, sub-stream mapping information, a transparent interactive overlay, and error correction information.

In one embodiment, the interactive layer transmission module includes a replacement sub-stream data module that transmits replacement sub-stream data via a route communicating the transparent interactive overlay to the client in response to the client determining that sub-stream data is missing or is in error. In another embodiment, the source computer system includes at least one of a server, a mainframe computer, a workstation, a personal computer, a laptop computer, and a portable communication device. In yet another embodiment, the system includes a dynamic casting engine module that selects at least one of a transmission method, retransmission of sub-streams, transmission timing, and sub-stream content of the sub-streams. The selection is based at least one of on client dispersion, demand, and requested content. In another embodiment, the system includes a repeating system that changes a transmission of sub-streams transmitted by the transmission module to an alternate transmission with different transmission parameters.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system to send and receive rich media over a digital network in accordance with the present invention;

FIG. 2 is a schematic block diagram illustrating one embodiment of an apparatus for delivering rich media over a digital network in accordance with the present invention;

FIG. 3 is a schematic block diagram illustrating one embodiment of an apparatus for receiving rich media over a digital network in accordance with the present invention;

FIG. 4 is a schematic flow chart diagram illustrating one embodiment of a method for delivering rich media over a digital network in accordance with the present invention;

FIG. 5 is a schematic flow chart diagram illustrating an alternate embodiment of a method for delivering rich media over a digital network in accordance with the present invention;

FIG. 6 is a schematic flow chart diagram illustrating one embodiment of a method for receiving rich media over a digital network in accordance with the present invention;

FIG. 7 is a schematic flow chart diagram illustrating an alternate embodiment of a method for receiving rich media over a digital network in accordance with the present invention; and

FIG. 8 is a schematic block diagram illustrating a particular embodiment of a system to send and receive rich media over a digital network in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. When a portion or an entire module is implemented in software, the software portion is stored on computer readable media. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

A system in accordance with the present invention may send out separate, synchronized unicast and/or multicast streams. The streams may be combined by a client application such that the unicast stream provides a transparent, interactive layer overlaying the multicast rich media stream. The interactive layer may comprise a “low overhead” video element or a series of static images or image maps relating to the non-static or video content of the rich media. In some embodiments, a third-party authoring system may create interactive, transparent, animation layers or video layers (e.g. Flash layers).

In selected embodiments, multiple multicast streams may be synchronizing on the client side with or without input from a synchronized unicast layer or client side application. Advantages for such delivery may be at least twofold. First, for animation, gaming, or personalizable video content, the publisher may send multiple multicast streams at various start times. The start times may be dynamically adjusted based on demand. A client application may then assemble the streams into a whole, switching the various parts as dictated by the user interaction. This allows for a seemingly unique and dynamic video, gaming, or animation presentation as well as a massive, yet efficient, internet-based, multi-player video-game. Second, “component video” may be sent in multiple, multicast streams that are synchronized on the client side. This may allow high quality video data (i.e. DVD/HD quality) to more efficiently move over an expanded network to multiple display terminals allowing the consumer greater content control.

In certain embodiments, an interaction layer or client-side application may be employed to identify user interaction. The user interaction may, in turn, dictate what multicast streams are tapped or what unicast stream or streams will be sent to effect a desired change in the rich media. For example, in some embodiments, user interaction may dictate a preferred camera angle in an internet broadcast. In other embodiments, user interaction may allow a video-game to operate efficiently on a large network. In still other embodiments, user interaction may allow an original animation or movie to be unique to a particular viewer or group of viewers.

In selected embodiments, unicast streams may be used in place of a multicast stream, relying on the uniqueness of sending distinct streams to the client application for synchronous, concurrent playback. This practice may provide advantages in file transfer, streaming speed, error correction, and presentation quality. A similar practice may be applied to any rich media, individually or collectively. Thereby, allowing component video and component audio, like separate audio “tracks,” to be sent separately and synchronized on the client side.

Casting of rich media may be synchronized at the local machine for a coordinated and harmonious presentation. Additionally, synchronization may be coordinated and harmonious with a group of disparate clients viewing terminals having “n” number of such terminals on “n” number of disparate end networks. This may be necessary where rich media is applied to something such as an online dating experience where two individuals in remote places interact in a voice or video chat environment while enjoying a rich media presentation. With current systems, it is impossible to guarantee that these two parties are observing the same content at the same time.

In selected embodiments, rich media streams may be synchronized concurrently, in parallel, some combination thereof, or simply sent to the client-side workstation in separate downloads that may be used concurrently and synchronously by the client application.

In certain embodiments, a system in accordance with the invention may provide error correction across multiple concurrent streams, rather than interlacing within the same stream. This concept is not unlike a striped, RAID array where each stream is analogous to a separate drive or other storage medium. Using three or more concurrent streams, any stream may disconnect or drop data, and the client application may use data from the other streams to reconstruct the missing data.

If desired, all streams may be synchronized at the server side by one or more coordinating servers. Accordingly, the player or client application may receive a map or table before, or concurrently with, the streams for playback coordination. In selected embodiments, packets may be encoded with synchronizing data for concurrent synchronous playback by a player. The player may match the streams by the given sequential encoding (whether alphabetical, numeric, ascending, descending, etc.) and buffer until the streams may be aligned.

In certain embodiments, systems in accordance with the present invention may segment a media file by component as defined above and then systematically divide these component subfiles into even smaller increments for faster travel over the network (whether unicast or multicast).

If desired, one or more streams may be scrambled to provide pay-per-view functionality and parental controls. In such embodiments, a key may be added by the user to unscramble the packet and restore proper sequencing. In some embodiments, one or more of the subcomponents may flow through, without the key, such that the picture is without contrast or without blue and green, etc., to motivate a pay-per-view purchase. In still other embodiments, sequencing may be scrambled in varying degrees of distortion. Generally speaking, interferences as described hereinabove may be controlled by a user interface on the client application (i.e. for parental controls), a server based on Cookie or Login processes, or some combination thereof.

In selected embodiments, streams may be scrambled in any number of ways. Such streams may be decoded on the client-side application or workstation. If desired, decoding may be dynamically controlled by the server. That is, the scrambling may change the key from time to time within the same presentation. Such functionality may protect subscription content from capture or viewing by non-subscribers or unauthorized players.

In certain embodiments, user interaction with the player or the synchronous transparent layer may be assessed to determine what point in the synchronous play the rich media is paused, stopped, rewound, switched to a different stream, etc.

If desired, a centralized server may be used to coordinate the use of various streams made available to client applications, whether individually or in combination with other players on disparate terminals in disparate end networks. This may facilitate playback of individual and multiple players for diverse purposes including web theatre, group shopping, true live event management, etc. It may also emulate DVR functionality (e.g. stop, start, pause, skip back, skip forward, etc.), including scene selection, through a web page delivered to the client application or within the transparent layer. Such a web page may preselect various streams that may be switched to either backward or forward, and manage the switching of streams for other purposes such as a change in camera angle, change in “channel,” etc.

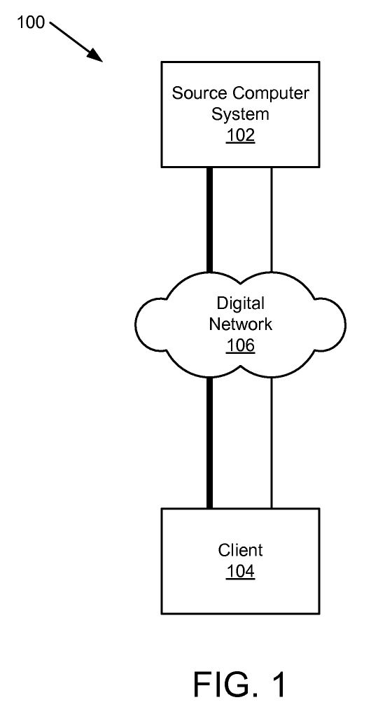

FIG. 1 is a schematic block diagram illustrating one embodiment of a system 100 to send and receive rich media over a digital network in accordance with the present invention. The system 100 includes a source computer system 102, a client 104, and a digital network 106, which are described below.

The source computer system 102 communicates with a digital network 106 and is configured to deliver rich media over the digital network 106. The source computer system 102 may include one or more servers running on at least one computer and may include one or more computers in communication with each other. The source computer system 102 may include a server computer, a workstation, a mainframe computer, a personal computer, a laptop computer, a terminal, printers, scanners, and the like as well as cables, routers, switches, etc. to connect the computer equipment. One of skill in the art will recognize other ways to configure a source computer system 102.

The source computer system 102 includes a way to connect to or input rich media. For example, the source computer system 102 may include an Internet link, a Digital Video Disc (“DVD”) player, a tape player, an MP3 player, etc. to allow rich media to be uploaded. The source computer system 102 may also use a combination of input devices. The source computer system 102 may also include means to input live rich media from a recording source, such as a television studio, recording studio, etc. One of skill in the art will recognize other ways to input rich media into the source computer system 102.

The rich media includes at least video content and/or audio content. Rich media typically includes more information than raw video and audio content. For example, rich media may include information coded using an extended markup language, such as web links. The information added to video and/or audio content may be transparent to a client 104 receiving the rich media and typically allows a degree of interactivity. The added information may be called a transparent interactive overlay.

Examples of information that may be include in the transparent interactive overlay include synchronizing information, addressing information, error correction information, textual information such as subtitles for a movie, advertising, encryption information, subscription and programming information, and the like. One of skill in the art will recognize other information to include in a transparent interactive overlay.

The system 100 also includes a client 104 in communication with the source computer system 102 over a digital network 106. The client 104 is configured to receive rich media sent from the source computer system 102 using two or more sub-streams and then to combine the sub-streams to form rich media for display, storage, partial storage, etc. The client 104 may include a single device or may be a system. The system 100 may also include multiple clients 104.

In one embodiment, the client 104 includes a computer such as a personal computer, a laptop computer, a server, a workstation, and the like. In another embodiment, the client 104 includes some type of media player or related equipment such as a gaming platform, a television, a DVD player, a set-top box, a satellite receiver, a projection system, a video cassette recorder (“VCR”), a portable audio or video player, a video conferencing system, an audio or video phone, or a digital radio. In another embodiment, the client 104 includes other devices that may use rich media such as an appliance or portable communication device, such as a personal digital assistant (“PDA”), mobile phone with media capabilities, etc. In yet another embodiment, the client 104 includes a combination of the devices mentioned above. One of skill in the art will recognize other embodiments of a client 104 configured to receive sub-streams and combine the sub-streams to form rich media.

The system 100 includes a digital network 106 configured to receive sub-streams derived from rich media from a source computer system 102 and to deliver the sub-streams to one or more clients 104. The digital network 106 may comprise a system of one particular type or may include a combination of system types. The digital network 106 may include one or more of an Internet Protocol (“IP”) network, a satellite broadcast system, an over-the-air broadcast system, a local area network, a wide area network, a wireless network, and a storage area network, and the like. One of skill in the art will recognize other systems and networks that may be used or combined to form a digital network 106.

In one embodiment, the digital network 106 includes a dynamic casting engine to consider relevant data about the sub-streams from various data sources, the likely or known audience dispersions, dimensions and dynamics, and rights related data, and any other relevant data, against a set of rules that determine optimal transport protocols and routing for each component. The dynamic casting engine may then direct the source computer system 102 to finally send the sub-streams out to the client 104 over the digital network 106. In another embodiment, the dynamic casting engine is included in the source computer system 102.

In other embodiments, the system 100 includes an optional proxy or repeating system to “reconsider” the source computer system's 102 choice (possibly made by a dynamic casting engine) of multicasting or unicasting of a particular stream. It may also serve to synchronize like streams to disparate clients 104 on disparate portions of the digital network 106. The optimal proxy or repeating system can then review the data, rules and network topology closer to the client 104 and determine if a multicast stream, or set thereof, should best be converted to a unicast, and vice versa. The optimal proxy or repeating system can also mitigate identity and transactional data between advertisers and clients 104 for privacy, security, ease of transaction (informational as well as financial), and many more functions.

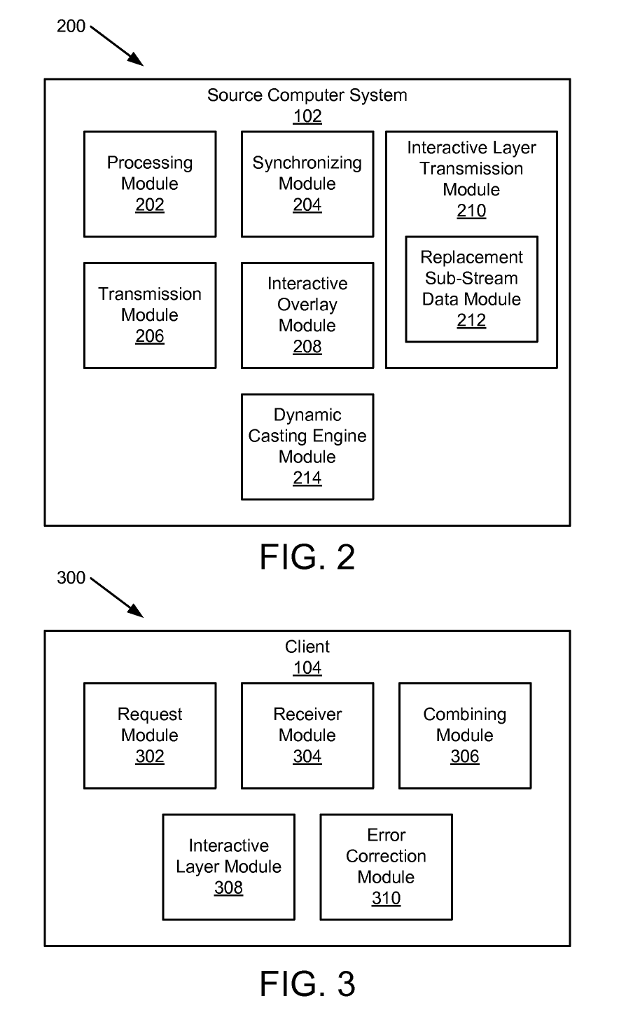

FIG. 2 is a schematic block diagram illustrating one embodiment of an apparatus 200 for delivering rich media over a digital network in accordance with the present invention. The apparatus 200 includes a processing module 202, a synchronizing module 204, and a transmission module 206. In other embodiments, the apparatus 200 may include an interactive overlay module 208, an interactive layer transmission module 210 with a replacement sub-stream data module 212, or a dynamic casting engine module 214, which are described below.

The apparatus 200 includes a processing module 202 processes rich media in two or more sub-streams. The rich media includes video content and/or audio content. The two or more sub-streams include digital packets for transport over IP networks. In one embodiment, the processing module 202 divides rich media into two or more sub-streams. In one example, rich media is a composite source that is divided into component streams. For example, the rich media may be divided into RGB analog component video streams, Y′P_{b}Pᵣ analog component video streams, S-Video analog component video streams, or other analog component-type video streams, and may then digitally encode the streams.

The processing module 202 may also divide out one or more audio streams, such as stereo signals to different speakers, different language tracks, etc. For example, the processing module 202 may divide rich media into streams suitable for an RCA format. The processing module 202 encodes video and audio streams where necessary into digital packets suitable for transport on an IP network. The processing module 202 may also divide digital rich media into sub-streams.

The processing module 202 may also divide rich media into various tracks such as audio tracks, composite video tracks of different camera angles, etc. The video tracks may be further divided into some type of component format. For example, the processing module 202 may divide out different microphone signals of an orchestra. In certain embodiments, the processing module 202 may divide out tracks on a master tape or other similar source where the various signals are separated in some way. In other embodiments, the processing module 202 divides composite video and/or audio into sub-streams using conversion techniques that create component streams.

In one embodiment, the processing module 202 divides out a transparent interactive overlay from rich media as a sub-stream. The remaining rich media content may then comprise one stream or may be further divided into sub-streams. The transparent interactive overlay sub-stream may then be synchronized with the rich media sub-stream(s) by the synchronizing module 204 as described below.

The processing module 202, in another embodiment, processes sub-streams from a rich media source that exists in a sub-stream format. The processing may include encoding the sub-streams from the rich media into a digital format or into digital packets suitable for transport over IP networks. The processing module 202 may also process sub-streams of rich media to add metadata. One of skill in the art will appreciate other ways for a processing module 202 to divide or otherwise process rich media so that the rich media is in two or more sub-streams and includes digital packets suitable for transport over IP networks.

In one embodiment, the processing module 202 compresses sub-streams. Compressing component streams may be efficient depending on the component scheme. Often palletized component data is more compressible than composite video data. Compressing sub-streams in a component format and then transmitting the sub-streams prior to decompression can be more efficient than compressing and transmitting composite streams prior to decompression. Sub-streams other than component streams may also be desirable.

The apparatus 200 includes a synchronizing module 204 that adds synchronizing information to the two or more sub-streams by adding sequence information to the digital packets of each stream. Digital packets of the two or more sub-streams that correspond to a point in play each include a sequence identifier indicating the point in play. The synchronizing information is sufficient for the client 104 to combine the sub-streams to form the rich media.

For example, the rich media may be processed into three digital sub-streams, A, B, and C, and divided into packets. The A sub-stream may be divided into packets A1, A2, A3, . . . . The B and C sub-streams may similarly divided into packets, B1, B2, B3, . . . and C1, C2, C3, . . . . Digital packets A1, B1, and C1 may correspond so that when combined they properly form a segment of the rich media. Similarly, packets A2, B2, and C2 may correspond, packets A3, B3, and C3 may correspond, etc. In one embodiment, the synchronizing module 204 adds a sequence identifier such as a numerical sequence to the packets. For example, the synchronizing module 204 may add number 0001 to packets A1, B1, and C1, number 0002 to packets A2, B2, and C2, etc.

In another embodiment, the synchronizing module 204 adds a sequence identifier to each packet that corresponds to a time. For example, the synchronizing module 204 may add 0:00:00:00 to packets A1, B1, and C1, which may correspond to the beginning of the rich media. The synchronizing module 204 may add 0:00:00:01 to packets A2, B2, and C2, which represents one hundredth of a second past the beginning of the rich media, and 0:00:00:02 to packets A3, B3, and C3, which represents two hundredths of a second past the beginning of the rich media.

In yet another embodiment, the synchronizing module 204 adds a time stamp to the packets. For example, the synchronizing module 204 may add 20:00:00:00 to packets A1, B1, and C1, which may correspond to 10:00 PM. Ten o'clock PM may correspond to a time the rich media was authored or may represent real time processing of the synchronizing module 204. The synchronizing module 204 may add 20:00:00:01 to packets A2, B2, and C2, which represents one hundredth of a second past 10:00 PM, the synchronizing module 204 may add 20:00:00:02 to packets A3, B3, and C3, which represents two hundredths of a second past 10:00 PM, etc.

The sequence identifiers are added to the packets of the sub-streams so that the packets may be combined at the client 104 in the proper order to form the rich media from the sub-streams and for the client 104 to identify any missing packets. Other synchronizing information may also be added to packets of the sub-streams. One of skill in the art will recognize other ways for the synchronizing module 204 to add synchronizing information to digital packets of the sub-streams.

The apparatus 200 includes a transmission module 206 that transmits the two or more sub-streams concurrently over one or more digital networks 106 to the client 104 for the client 104 to combine the sub-streams to form the rich media. The transmission module 206 transmits each of the sub-streams over a different route and each route corresponds to a unique sub-stream address. The client 104 requests transmission of the sub-streams from the unique sub-stream addresses. Using different routes for each sub-stream is beneficial because the sub-streams may be transmitted in parallel. Transmitting multiple sub-streams spreads the bandwidth requirement of the rich media as a whole over multiple routes to increase the throughput of the transmission.

In one embodiment, the transmission module 206 transmits the sub-streams using a multicast. Delivery using a multicast is beneficial because the message is delivered once from the source computer system 102 over each link (excluding re-transmission of missing packets). Where a sub-stream is delivered to multiple clients 104, packets of the sub-stream are copied at a branch point closest to the clients 104. For example, a sub-stream A may be delivered to three clients 104, X, Y, and Z. The digital network 106 may include three routers, R1, R2 and R3, between the source computer system 102 and the clients 104. Client X and Client Y may be connected through router R2 and Client Z may be connected to router R3. Router R1 may connect routers R2 and R3.

The transmission module 206 may transmit packets only to Client X if Client X is the only subscriber. Packets would be transmitted only to Routers R1 and R2. If Client Y joins the multicast, packets of sub-stream A are copied only at router R2 and sent to Client Y. The packets are not re-sent from the source computer system 102 or from Router R1 because the packets can be found at router R2. If Client Z joins the multicast, Router R1 copies the required packets and sends them to Router R3, which sends them to Client Z. Again, the source computer system 102 is not required to resend the packets because the packets may be found on Router R1. Multicasting is efficient because the source computer system 102 typically only sends the packets once. A multicast, however, is client 104 driven and when used alone lacks interactivity.

The transmission module 206, in another embodiment, transmits the packets using a unicast. A unicast is most efficient when servicing a relatively few number of clients 104 and has the advantage of having a bi-directional capability. A unicast typically has a much lower bandwidth than a multicast but may be interactive. In one embodiment, a sub-stream containing a transparent interactive overlay is sent using a unicast and one or more other sub-streams of the rich media are sent using a multicast. Advantageously, this embodiment provides an efficient way to stream rich media data using a high bandwidth multicast, which flows one-to-many, while allowing transparent interactive overlay information, which may be limited in its bandwidth requirements, over a unicast, or one-to-one source bandwidth to consumer ratio—allowing interactivity with the source computer system 102.

In other embodiments, the sub-streams are transmitted using a broadcast, anycast, or the like. The transmission module 206 may also transmit the sub-streams using different methods for each sub-stream or may use a combination of transmission methods for any one sub-stream. One of skill in the art will recognize other ways for the transmission module 206 to transmit sub-streams to a client 104 over different routes.

The apparatus 200 includes an interactive overlay module 208 that creates a transparent interactive overlay corresponding to the rich media and synchronized to one or more sub-streams of the rich media. In one embodiment, the interactive overlay module 208 creates transparent interactive overlay information. For example, the interactive overlay module 208 may create the synchronizing information used by the synchronizing module 204. In another example, the interactive overlay module 208 may create address information that identifies where the sub-streams can be accessed. In another example, interactive overlay module 208 may create error information, such as location of an error correction server, code to determine if an error exists, error correction code, or information to recreate missing data of a sub-stream from two or more other sub-streams. Error correction will be discussed below in more detail.

The interactive overlay module 208 may also create markup language data such as links related to the rich media, textual data, channel information, programming information, mapping data, and the like. In another embodiment, the interactive overlay module 208 creates a transparent interactive overlay by processing information extracted from the rich media, such as subtitles in alternate languages, or retrieves information from other sources. For example, the interactive overlay module 208 may retrieve channel programming information from an electronic programming guide. The interactive overlay module 208 may then prepare the retrieved or extracted information as a transparent interactive overlay. The interactive overlay module 208 then synchronizes any created, extracted, or retrieved information used to create the transparent interactive overlay to one or more of the sub-streams.

In one embodiment, the interactive overlay module 208 synchronizes a portion of or the entire transparent interactive overlay by attaching or merging it with one or more sub-streams. In another embodiment, the interactive overlay module 208 creates a separate, interactive layer sub-stream containing a portion of or the entire transparent interactive overlay and synchronizes the newly created sub-stream with the one or more other sub-streams of the rich media.

The apparatus 200 includes an interactive layer transmission module 210 that transmits the interactive layer sub-stream (“interactive layer”) to the client 104. Preferably, the interactive layer is transmitted by the transmission module 206 using a unicast for bi-directional, interactive communication between the source computer system 102 and a client 104.

In one embodiment, the interactive layer transmission module 210 includes a replacement sub-stream data module 212 that provides replacement sub-stream data to a client 104. The replacement sub-stream data module 212 transmits replacement sub-stream data via a route communicating the transparent interactive overlay to the client 104 in response to the client 104 determining that sub-stream data is missing or is in error. Typically, the replacement sub-stream data is sent when a client 104 determines that one or more packets of a sub-stream are missing or are corrupted. In another embodiment, the replacement sub-stream data module 212 provides replacement sub-stream data to an error correction server, router, switch, or similar equipment for use by a client 104 seeking to the replacement sub-stream data. One of skill in the art will recognize other ways for the replacement sub-stream data module 212 to transmit replacement sub-stream data to a client 104.

The apparatus 200 includes a dynamic casting engine module 214 that selects a transmission method, such as multicasting, broadcasting, or unicasting, whether or not to retransmit the sub-streams, transmission timing, sub-stream content of the sub-streams, and the like. The dynamic casting engine module 214 bases selection on factors such as client 104 dispersion and digital network 106 configuration, demand for the rich media, requested content, etc. Typically the dynamic casting engine module 214 cooperates with the processing module 202 and synchronizing module 204 to process appropriate sub-streams and the transmission module 206 for the transmission method.

In one embodiment, if the dynamic casting engine module 214 determines that the demand for the rich media is light, the dynamic casting engine module 214 may select unicasting as the transmission method for the transmission module 206 to use to transmit the sub-streams. In another embodiment, the dynamic casting engine module 214 may select a minimum number of sub-streams unless the dynamic casting engine module 214 determines that more content is requested. For example, the dynamic casting engine module 214 may detect a client 104 request for a Spanish audio track. The dynamic casting engine module 214 may include a Spanish audio track sub-stream.

In another embodiment, the dynamic casting engine module 214 may detect an increase in demand for the rich media. The dynamic casting engine module 214, in one example, may change the transmission method from a unicast to a multicast. In another example, the dynamic casting engine module 214 may direct the transmission module 206 to retransmit the sub-streams. The dynamic casting engine module 214 may also direct the interactive layer transmission module 210 to transmit additional addresses for the retransmitted sub-streams to a new client 104 requesting the rich media. One of skill in the art will recognize other selections that may be made by the dynamic casting engine module 214 to optimize transmission of the sub-streams based on various demand and configuration factors.

FIG. 3 is a schematic block diagram illustrating one embodiment of an apparatus 300 for receiving rich media over a digital network in accordance with the present invention. The apparatus 300 includes a request module 302, a receiver module 304, and a combining module 306, which are described below. Optionally, the apparatus 300 also includes an interactive layer module 308 and/or an error correction module 310, which are described below.

The apparatus 300 includes a request module 302 that requests receipt of two or more sub-streams over the digital network 106. Each sub-stream is requested from a different address and the sub-streams include digital packet data suitable for transport over IP networks. The sub-streams are combined with synchronizing information. The synchronizing information includes sequence information added to the digital packets of each stream. Digital packets of the two or more sub-streams that correspond to a point in play each include a sequence identifier indicating the point in play.

The request module 302 requests each sub-stream using a unique address for each sub-stream. By requiring different addresses for different sub-streams, the sub-streams are transmitted over different routes so that the sub-streams can be transmitted in parallel to reduce bandwidth requirements on any one route. The client 104 typically receives address information from the source computer system 102, but may receive the address information from another source, such as another computer, a DVD, a CD, a tape, a web page, etc. Preferably, the client 104 receives address information as part of an interactive layer transmitted using a unicast.

The apparatus 300 includes a receiver module 304 that receives the sub-streams. The receiver module 304 may receive sub-streams by way of a multicast, unicast, broadcast, etc. The receiver module 304 preferably receives a sub-stream that includes an interactive layer by way of a unicast over a bi-directional, keep-alive connection. The receiver module 304 preferably also receives one or more other sub-streams through other routes by way of a multicast. In other embodiments, the receiver module 304 receives the sub-streams by way of multiple transmission methods.

Typically, the receiver module 304 buffers sub-stream digital packets before further processing to ensure that all packets are received and accounted for before processing. The buffering may be adjusted based on anticipated discrepancies between sub-streams, error correction time requirements, etc. One of skill in the art will understand other buffering requirements and methods and other ways that the receiver module 304 may receive sub-streams.

The apparatus 300 includes a combining module 306 that combines the sub-streams to form the rich media based on the synchronizing information contained in the sub-streams. The rich media includes at least video data or audio data. The combining module 306 typically locates digital packets in the sub-streams that include the same sequence identifier and then combines the packets. Combining the packets may include aligning packets with the same sequence identifier in a data structure, merging two or more digital packets, and the like. The combining module 306 may also extract transparent interactive overlay data from one or more of the sub-streams and then process the transparent interactive overlay data. Processing the transparent interactive overlay data may include processing in sequence with other digital packets with a same sequence identifier.

After the sub-streams are combined, the client 104 may store the formed rich media for later playback or may display the formed rich media immediately and linearly. In another embodiment, the client 104 stores a portion of the formed rich media and then displays the rich media prior to receiving complete sub-streams. This function is similar to the action of a digital video recorder (“DVR”) allowing a user to watch a program that is in progress. The client 104 may allow a user to search the rich media by moving forward or back within the formed rich media, pause or stop display of the rich media, etc.

The client 104 may also utilize transparent interactive overlay information to examine a programming guide, change programming channels, display web sites or other data linked to the rich media, display advertising, etc. One of skill in the art will recognize other ways that the combining module 306 may combine sub-streams to form rich media and then to use the formed rich media. In another embodiment, the sub-streams may be decompressed prior to combining the sub-streams to form the rich media.

In one embodiment, the combining module 306 descrambles sub-streams that are received in a scrambled format. Various levels of scrambling can be used to fully scramble sub-streams and formed rich media, to scramble formed media such that a display is only slightly distorted, or anywhere in between. The interactive layer module 308 may be used to receive descrambling information such as encryption keys, subscription confirmation information, etc. so that the combining module 306 may decrypt rich media or sub-streams or may simply descramble the rich media or sub-streams. The interactive layer module 308 may be used to receive dynamic encryption keys that may change based on client subscription status, parental control input, program rating, etc. One of skill in the art will recognize other ways to manage and execute scrambling and descrambling of the formed rich media and/or received sub-streams.

The apparatus 300 includes, in one embodiment, an interactive layer module 308 that receives an interactive layer synchronized to one or more of the sub-streams. The interactive layer also corresponds to the rich media from which the sub-streams were processed. The interactive layer may include synchronizing information, error correction information, or other information that may be included in a transparent interactive overlay. Preferably the interactive layer module 308 communicates dynamically with the source computer system 102 or other source with transparent interactive overlay data relevant to the received sub-streams.

In one embodiment, the interactive layer module 308 receives as interactive layer directed to and customized specifically for the client 104. In another embodiment, the interactive layer module 308 receives an interactive layer directed to and customized specifically for a targeted group of clients 104. For example, the interactive layer module 308 receives advertising or messages directed to the client 104 based on a user profile. In another example, the interactive layer module 308 receives subscription information or programming information based on a client 104 subscription status. In an alternate embodiment, the interactive layer module 308 receives an interactive layer directed to a group of clients 104. The group may be determined by common characteristics of the clients 104, such as user profiles, shopping habits, etc. One of skill in the art will recognize other ways to direct a custom interactive layer to a specific client 104 or specific group of clients 104.

In one embodiment, the interactive layer module 308 receives replacement sub-stream data and combines the replacement sub-stream data with a sub-stream to form a corrected sub-stream in response to detecting that a sub-stream is missing data or has incorrect data. The interactive layer module 308 may monitor sequence indicators, error correction data, etc. to determine if replacement sub-stream data is desired or required. If replacement sub-stream data is missing, corrupted, or otherwise unusable, the interactive layer module 308 may request replacement sub-stream data from the source computer system 102 or an error correction computer.

Meanwhile, processing or combining of the sub-streams may be delayed. Preferably, a buffer storing the sub-streams or formed rich media is large enough to allow detection and correction of an error before the missing or corrupt data is required for viewing, listening, etc. Once the replacement sub-stream data is received, the interactive layer module 308 combines the replacement sub-stream data with the proper sub-streams so that packets of sub-streams are properly sequenced and contain correct data. While the error correction is taking place, the receiver module 304 may continue to receive digital packets from the sub-streams without interruption.

In another embodiment, the apparatus 300 includes an error correction module 310 that corrects a sub-stream error using error correction data from a sub-stream. For example, a packet of a sub-stream may contain error-correcting code (“ECC”). The ECC may be used to correct single-bit errors and detect double-bit errors. More sophisticated ECC may also be used to detect and correct errors of higher orders.

In another embodiment, the error correction module 310 may correct a sub-stream error from data contained in other sub-streams. This embodiment would function similar to correcting errors using stripped data stored in a redundant array of independent/inexpensive disks (“RAID). In other embodiments, the error correction module 310 cooperates with or is part of the interactive layer module 308 to correct errors. One of skill in the art will recognize other ways that an error correction module 310 and an interactive layer module 308 may correct errors in sub-stream data.

Some examples of advantages of the system 100 and apparatuses 200, 300 described above include:
Fully interactive multicast can be achieved by authoring and synchronizing a transparent unicast layer to ride on top of a non-interactive multicast stream, such as a video, creating the appearance and function of clickable video elements.
Multicast can be “repaired” leveraging a unicast layer and/or several multicast layers that contain forward error correction or backchannel correction processes embedded.
More efficient transport of high-quality video may be achievable by sending S-Video components, compressed and sent separately, and re-synchronizing them in the receiving process.
More rich media optional or alternative sub-streams can be communicated allowing a user to “remix” the sub-streams at the client 104.
Multiple audio/language tracks can be sent live with a certain video property leveraging user choice to reduce overall network congestions.
Other benefits derive from the authoring process that may improve the user experience. One such example is the ability to search rich media properties more fully due to the mapping of meta data which might include descriptions, titles, cast, viewer ratings, audience measurement from prior play, dialogue, and more, to the full length of play making even subsets of a rich media stream searchable, and making highly-specific content filtering options possible.
If the sub-streams are also sent through an optional proxy or repeating system additional effects can be created, such as synchronizing play in disparate receivers on disparate networks within a third party chat system effectively creating a rich media social environment much akin to a web theatre which could be used for private screenings, live hosted rich media events, online movie dates, and etc.

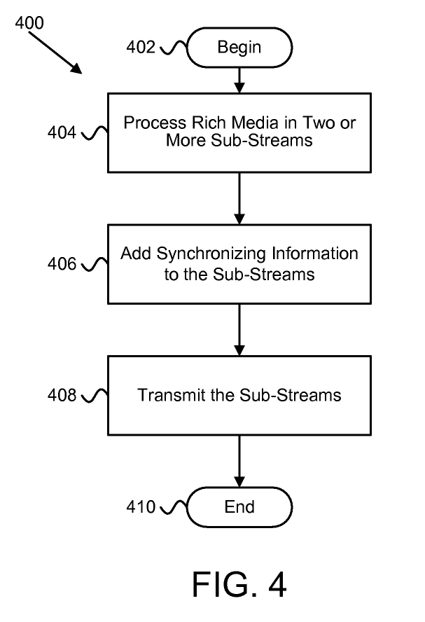

FIG. 4 is a schematic flow chart diagram illustrating one embodiment of a method 400 for delivering rich media over a digital network in accordance with the present invention. The method 400 begins 402 and the processing module 202 processes 404 rich media in two or more sub-streams. The rich media includes video and/or audio content and the two or more sub-streams formatted into digital packets for transport over IP networks. The processing module 202 may process rich media that exists in sub-streams or may divide rich media into two or more sub-streams.

The synchronizing module 204 adds 406 synchronizing information to the sub-streams by adding sequence information to the digital packets of each sub-stream. The sequence information is added such that the digital packets of each sub-streams that correspond to a particular point in play each include a sequence identifier indicating the particular point in play. The sequence information may then be used by the client 104 to combine the sub-streams to form the rich media. The transmission module 206 transmits 408 the sub-streams over one or more digital networks 106 to one or more clients 104 and the method 400 ends 410. The clients 104 may then combine the sub-streams into the rich media. The sub-streams are transmitted over different routes to the clients 104 and the clients 104 request each sub-stream separately from different addresses that correspond to the sub-streams.

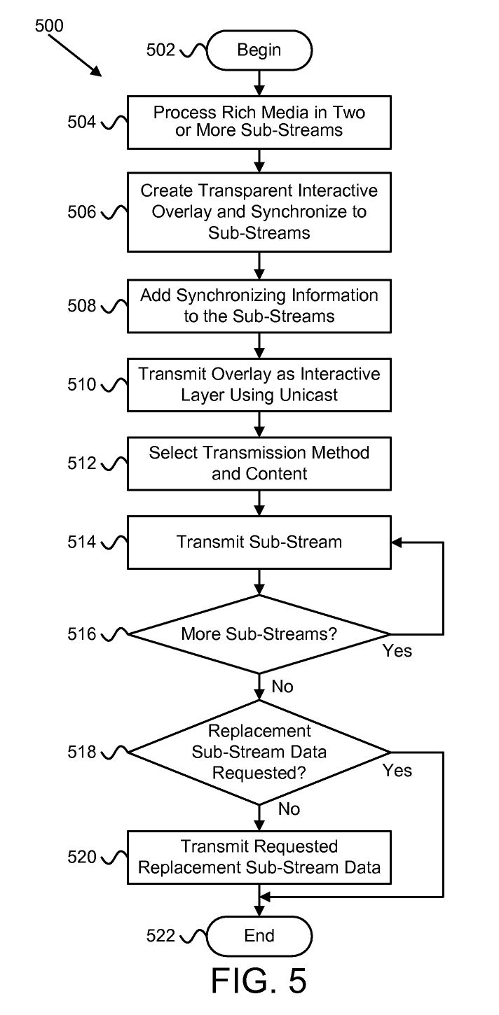

FIG. 5 is a schematic flow chart diagram illustrating an alternate embodiment of a method 500 for delivering rich media over a digital network in accordance with the present invention. The method 500 begins 502 and the processing module 202 processes 504 rich media in two or more sub-streams. The interactive overlay module 208 creates 506 a transparent interactive overlay and synchronizes it to one or more sub-streams.

The synchronizing module 204 adds 508 synchronizing information to each digital packet of the sub-streams such that packets corresponding to a point in play each include the same sequence identifier. The interactive layer transmission module 210 transmits 510 at least a portion of the transparent interactive overlay configured as an interactive layer to the client 104 using a bidirectional unicast. The dynamic casting engine module 214 selects 512 a transmission method. For example, if there are few clients 104 requesting the rich media, the dynamic casting engine module 214 may select a unicast. If there many clients 104 requesting the rich media, the dynamic casting engine module 214 may select a unicast.

The dynamic casting engine module 214 also selects 512 content of the sub-streams. For example, if subtitles are requested, the dynamic casting engine module 214 may cooperate with the processing module 202 to add another sub-stream with the subtitles or may add the subtitles to one of the sub-streams. Note that the steps of the method 500 may be executed in any order or may execute simultaneously. For example, the dynamic casting engine module 214 may be part of the processing module 202 and may determine how many sub-streams are require and the content of the sub-streams prior to processing 504 by the processing module 202. One of skill in the art will recognize that other ways that the steps of the method may execute for the steps listed above as well the steps described below.

The transmission module 206 transmits 514 a sub-stream using a transmission method selected 512 by the dynamic casting engine module 214. For example, if the dynamic casting engine module 214 determines that multicasting is the transmission method, the transmission module 206 transmits the sub-stream using a multicast. The transmission module 206 determines 516 if there is another sub-stream to transmit. If the transmission module 206 determines 516 that there is another sub-stream to transmit, the transmission module 206 transmits 514 the sub-stream over a different route than any other transmitted sub-stream.

If the transmission module 206 determines 516 that there is not another sub-stream to transmit, the replacement sub-stream data module 212 determines 518 if replacement sub-stream data is requested. If the replacement sub-stream data module 212 determines 518 that replacement sub-stream data is requested, the replacement sub-stream data module 212 transmits 520 the requested replacement sub-stream data over the communication pathway that the interactive layer transmission module 210 transmits 510 the interactive layer and the method 500 ends 522. If the replacement sub-stream data module 212 determines 518 that replacement sub-stream data is not requested, the method 500 ends 522.

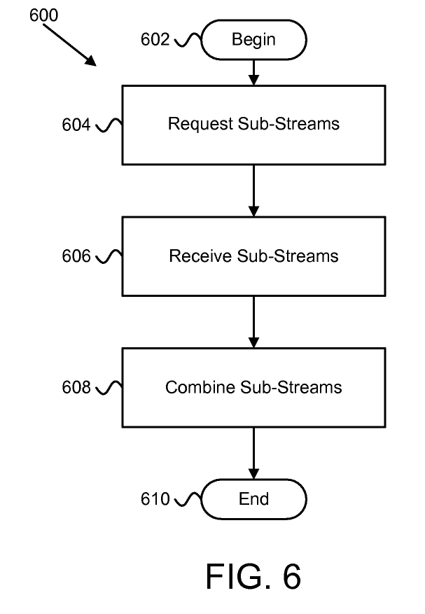

FIG. 6 is a schematic flow chart diagram illustrating one embodiment of a method 600 for receiving rich media over a digital network in accordance with the present invention. The method 600 begins 602 and the request module 302 requests 604 two or more sub-streams over the digital network 106 by requesting each sub-stream from a different address. The requested sub-streams comprise digital packets suitable for transmission over an IP network and are combined with synchronizing information. The synchronizing information includes sequence information added to the digital packets of each sub-stream such that digital packets of the sub-streams that each correspond to a particular point in play each include a sequence identifier that indicates the point in play.

The receiver module 304 receives 606 the sub-streams over different routes. The sub-streams may be buffered to allow for different transmission times of the sub-streams. The combining module 306 combines 608 the sub-streams to form the rich media based on the synchronizing information contained in the sub-streams and the method 600 ends 610. The formed rich media includes video and/or audio content.

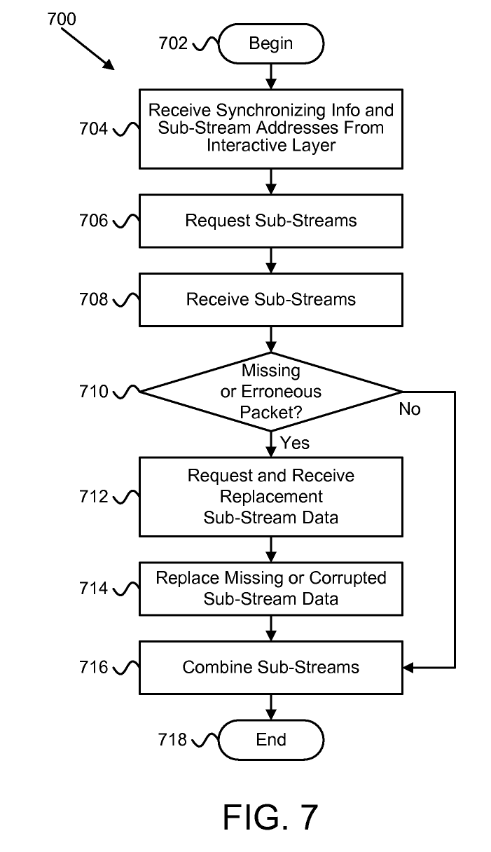

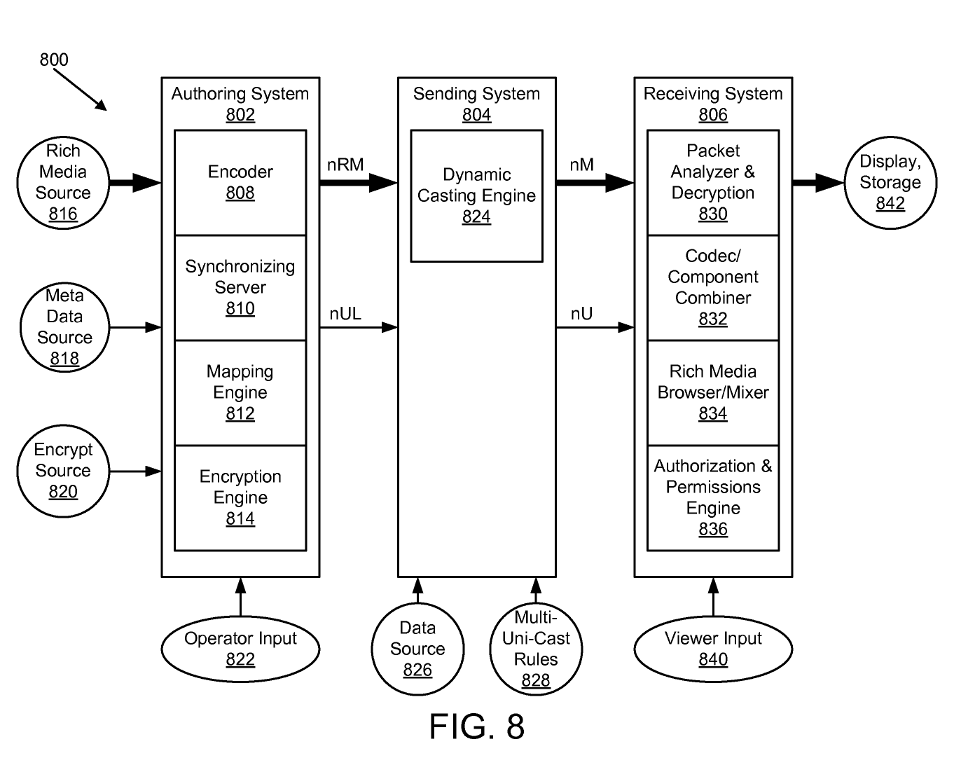

FIG. 7 is a schematic flow chart diagram illustrating an alternate embodiment of a method 700 for receiving rich media over a digital network in accordance with the present invention. The method 700 begins 702 and the interactive layer module 308 receives synchronizing information and sub-stream addresses from the interactive layer transmitted using a unicast. The request module 302 requests 706 two or more sub-streams over the digital network 106 by requesting the sub-streams from the addresses received 704 through the interactive layer module 308. The receiver module 304 receives 708 the sub-streams, each over a different route.

The error correction module 310 determines 710, in one embodiment, if any packets are missing or corrupted. If the error correction module 310 determines that there are missing or corrupted packets, the interactive layer module 308 requests 712 and receives replacement sub-stream data. The interactive layer module 308, in one embodiment, replaces 714 the missing or corrupted digital packets with the replacement sub-stream data so that the sub-stream data packets are complete and correct. The combining module 306 combines 716 the sub-streams to form the rich media and the method 700 ends 718.

If the error correction module 310 determines 710 that there are no missing or corrupted digital data packets, the combining module 306 combines 716 the sub-streams to form the rich media and the method 700 ends 718. The client 104 may then store the rich media, view it, partially store the rich media while viewing, etc. One of skill in the art will recognize other ways that the client 104 may use the formed rich media.

FIG. 8 is a schematic block diagram illustrating a particular embodiment of a system 800 to send and receive rich media over a digital network in accordance with the present invention. The system 800 includes an authoring system 802, a sending system 804, and a receiving system 806. The authoring system 802 includes an encoder 808, a synchronizing server 810, a mapping engine 812, and an encryption engine 814. The authoring system 802 receives input from a rich media source 816, a metadata source 818, an encryption source 820, and operator input 822. The sending system 804 includes a dynamic casting engine 824 and receives input from a data source 826 and a source for multi- and uni-cast rules 828. The authoring system 802 and sending system 804 may be part of the source computer system 102 described above.

The encoder 808 and encryption engine 814, in one embodiment, are part of the processing module 202. The synchronizing server 810 and mapping engine 812, in another embodiment, are part of the synchronizing module 204. The dynamic casting engine 824, in another embodiment, is part of the dynamic casting engine module 214.

The receiving system 806, which is described above as a client 104, includes a packet analyzer and decryption engine 830, a codec/component combiner 832, a rich media browser/mixer 834, and an authorization and permissions engine 836. The receiving system 806 may receive viewer input 840 and may include display and storage 842 of the rich media. In one embodiment, the packet analyzer and decryption engine 830 and the codec/component combiner 832 are part of the combining module 306. In another embodiment, the authorizing and permissions engine 836 is part of the interactive layer module 308.

### Authoring System

The authoring system 802 may include computer hardware and software for encoding, stream splitting, encryption, data tagging, and any similar function related or possibly related to rich media delivery. The primary function of the authoring system 802 is to receive whole inputs from various sources and create connections or relationships between these disparate sources creating the necessary linkages necessary to allow a receiving system 806 to unite the disparate parts or sub-streams into a single whole rich media experience. The authoring system 802 does not physically combine the sub-streams.

There may be exceptions to the non-combinant function of the authoring system 802, such as the creation of a transparent interactive overlay (nUL) using markup language linking associated with a mapping, state/position identifiers, or a sequencing or some combination thereof to effectively unite the various non-rich media components into a single component which combined component would not be combined with the rich media layer. The reason for this is that the authoring system 802 will pass these components on to the sending system 804 where the sending system 804 will make decisions about how to best send the sub-streams. Where, if the authoring system 802 had combined them, such options would not be open to the sending system 804. For example (and this will be further clarified herein below) the rich media sub-stream(s) (nRM) will be substantially larger than the interactive transparent layer component. While the latter must be sent as a unicast, the former is best sent as a multicast. Furthermore, in combination with a proxy or repeater system, the streams may actually be able to switch back and forth between multicast and unicast as necessary to execute the most efficient transport available in an IP network.

A few examples showing the impacts and functions of the authoring system 802 where the authoring system 802 might receive video inputs from a Moving Pictures Experts Group (“MPEG”) 1 rich media or some other raw video source and may also receive a separate set of descriptive or actionable meta data containing descriptive data, ratings data, licensing data, web data, etc.
1. The MPEG1 signal may be processed involving transrating, transcoding and re-encoding into any number of codecs, such as an MPEG4 Advanced Video Coding (“AVC”). This MPEG4 stream may then pass through a mapping engine 812 that will allow an operator to synchronize metadata onto a transparent interactive layer. The two component parts are then sent on to the sending system 804.
2. The MPEG 1 signal may be processed involving stream splitting into its RGB components resulting in three component streams. Each resulting component stream may then be encoded (with a smaller color palette and perhaps only one component stream carrying contrast data) resulting in sending video in a higher quality pre-componentized fashion that will be lower in bandwidth.
3. The MPEG1 signal may be processed as in 2 above, but the authoring system 802 can include the creation and mapping of interactive transparent layer as in 1 above. Further, forward error correction (similar to a striped RAID array) may be employed across the separate component streams.
4. The MPEG 1 signal may be processed as in 1 or 2 above but with the audio tracks broken out, including music only, various dubbed languages, and certain data can be provided in multiple languages, such as within the Electronic Programming Guide, within Closed Captioning, within separate unicast overlays—where the viewer may choose the optimal combinations of sub-streams for his own viewing, thus maximizing bandwidth and user satisfaction

The authoring system 802 involves a synchronizing server 810 that plays the rich media while dynamically creating a transparent layer that is synchronized to the rich media stream. This transparent overlay layer or canvas can be a series of ‘n’ images (such as a transparent Graphics Interchange Format (“GIF”)), or a video containing only transparency (such as may exist in RGBA where the A or alpha component is a transparent video component) with hypertext markup image maps embedded or embeddable by a human operator or an algorithmic function.

The synchronizing server 810 would map frames and positions within frames as a common reference between the layers, mark frame position and packet sequence, mark frame position and playing or run time, or a like schema that can then be easily converted to a machine understandable IP network transportable information with which the receiving system 806 can re-form the linkages in real time during the play of the rich media.

The authoring system 802 may be used in the original creation of the rich media (non-live) by a content producer. This would effectively distribute the rich media delivery solution across a wide area IP network (digital network 106), likely involving the potential for multiple authoring systems 802 to be distributed among multiple disparate content producers where all may either also operate a local sending system 804 or feed the sub-streams to a centralized sending system 804. In short, the authoring system 802 is a series of hardware and software linked together to form relationships between synchronized sub-streams that remain separate during transport over IP networks.

### Sending System

The sending system 804 receives a plurality of sub-streams (nRM and nUL) from the authoring system 802 over an IP network and makes decisions about which sub-streams should be unicast (nU) and which should be multicast (nM) or which should be sent as both. The sending system 804 then transmits the sub-streams accordingly into a wide area IP network.

The sending system 804 is composed of hardware and software systems or subsystems linked together. In the preferred embodiment of the invention the sending system 804 is centralized on the wide area IP network. The sending system 804 includes a dynamic casting engine 824 that is described above.

### Receiving System

The invention then includes a receiving system 806 at the other end of an IP network to decompress (if necessary) and re-synchronize the IP streams. This is necessary as they would more than likely travel over the IP network in divergent paths due to protocol/routing isolations for unicast and multicast packet delivery. The invention may also include an optional proxy or repeating system within the IP network between the sending system 804 and the receiving system 806. The invention can yield many advantages that guarantee quality, reduce total stream bandwidth requirement, provide interactivity to a normally non-interactive technology, enhance security of rich media properties, and more. The optional proxy and repeating system is described above and may be part of the system 800.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer readable medium having: computer usable program code executable to perform operations for delivering rich media over a digital network, the operations of the computer program product comprising:
processing rich media in two or more sub-streams, the rich media comprising at least one of video content and audio content, the two or more sub-streams comprising digital packets for transport over Internet Protocol (“IP”) networks;
adding synchronizing information to the two or more sub-streams by adding sequencing information to the digital packets of each sub-stream, wherein digital packets of the two or more sub-streams that correspond to a point in play each include a sequence identifier indicating the point in play, the synchronizing information sufficient for a client to combine the sub-streams to form the rich media; and
transmitting the two or more sub-streams concurrently over one or more digital networks to the client for combining the sub-streams to form the rich media, wherein each of the two or more sub-streams is transmitted over a different route, each route corresponding to a unique sub-stream address, and wherein the client requests transmission of the sub-streams from the unique sub-stream addresses.

2. The computer program product of claim 1, further comprising creating a transparent interactive overlay corresponding to the rich media and synchronized to one or more sub-streams of the rich media.

3. The computer program product of claim 2, wherein the transparent interactive overlay comprises at least one of the synchronizing information, sub-stream address information, markup language data, text data, programming data, error correction data, and mapping data.

4. The computer program product of claim 2, wherein at least a portion of the transparent interactive overlay comprises an interactive layer that comprises one sub-stream of the two or more sub-streams.

5. The computer program product of claim 4, wherein the interactive layer is transmitted using a bi-directional unicast.

6. The computer program product of claim 2, wherein the transparent interactive overlay is combined with one or more of the sub-streams.

7. The computer program product of claim 1, wherein processing rich media in two or more streams comprises one of dividing sub-streams from the rich media and formatting for transmission rich media authored as sub-streams.

8. The computer program product of claim 1, further comprising transmitting replacement sub-stream data using an interactive layer to the client in response to the client determining that sub-stream data is missing or is in error.

9. The computer program product of claim 8, wherein transmitting replacement sub-stream data further comprises transmitting the replacement sub-stream data to an error correction server for use by a client requesting the replacement sub-stream data to correct a sub-stream.

10. The computer program product of claim 1, wherein at least one of the sub-streams is transmitted using one of multicast, a broadcast, and a unicast.

11. The computer program product of claim 1, wherein at least two sub-streams comprise error correction information sufficient to recreate missing or erroneous sub-stream data of a sub-stream.

12. The computer program product of claim 1, wherein a sub-stream comprises at least one of a composite rich media stream, a component stream, an audio stream, a transparent interactive overlay stream, a text stream, a markup language stream.

13. The computer program product of claim 1, further comprising transmitting sub-streams representing the rich media to two or more clients and transmitting an interactive layer over a bi-directional connection to each of the two or more clients.

14. The computer program product of claim 13, further comprising transmitting a customized interactive layer to at least one of the two or more clients or to each of a group of clients representing a subset of the two or more clients.

15. The computer program product of claim 14, wherein the customized interactive layer comprises at least one of advertising, customized programming, subscription data, encryption information, messages, and client-specific information.

16. A computer program product comprising a computer readable medium having computer usable program code executable to perform operations for receiving rich media over a digital network, the operations of the computer program product comprising:
requesting receipt of two or more sub-streams over a digital network, each sub-stream requested from a different address, the sub-streams comprising digital packet data suitable for transport over Internet Protocol (“IP”) networks and are combined with synchronizing information, the synchronizing information comprising sequence information added to the digital packets of each sub-stream, wherein digital packets of the two or more sub-streams that correspond to a point in play each include a sequence identifier indicating the point in play;
receiving the sub-streams; and
combining the sub-streams to form the rich media based on the synchronizing information contained in the sub-streams, the rich media comprising at least one of video data and audio data.

17. The computer program product of claim 16, further comprising receiving a transparent interactive overlay as part of one or more sub-streams, the transparent interactive overlay synchronized to one or more of the sub-streams and corresponding to the rich media from which the sub-streams were processed.

18. The computer program product of claim 17, wherein the transparent interactive overlay comprises at least one of the synchronizing information, sub-stream address information, markup language data, text data, programming data, error correction data, and mapping data.

19. The computer program product of claim 16, further comprising receiving an interactive layer via a bidirectional unicast from an address of the digital network different from an address of the one or more other sub-streams.

20. The computer program product of claim 19, wherein the interactive layer comprises one of the two or more sub-streams.

21. The computer program product of claim 19, wherein the interactive layer comprises at least one of the synchronizing information, sub-stream address information, markup language data, text data, programming data, error correction data, and mapping data.

22. The computer program product of claim 19, further comprising receiving sub-stream replacement data over the interactive layer and combining the sub-stream replacement data with a sub-stream to form a corrected sub-stream in response to detecting that a sub-stream is missing data or has incorrect data.

23. The computer program product of claim 22, wherein receiving sub-stream replacement data further comprises receiving sub-stream replacement data from an error correction server.

24. The computer program product of claim 16, wherein receiving the sub-streams further comprises receiving scrambled sub-streams and further comprising descrambling the sub-streams prior to combining the sub-streams.

25. The computer program product of claim 24, further comprising dynamically receiving one or more encryption or descrambling keys as part of an interactive layer received over a bi-directional connection, the encryption or descrambling keys used for decrypting or descrambling the sub-streams.

26. The computer program product of claim 16, further comprising correcting a sub-stream error using error correction data from one or more sub-streams.

27. The computer program product of claim 16, wherein the two or more sub-streams are received by way of one of a multicast, a broadcast, and a unicast.

28. The computer program product of claim 16, wherein receiving the sub-streams further comprises receiving one or more compressed sub-streams and further comprising decompressing the one or more sub-streams.

29. The computer program product of claim 16, further comprising at least one of storing one or more sub-streams for later playback, storing the formed rich media for later playback, partially storing one or more sub-streams or the formed rich media while displaying the formed rich media prior to complete receipt of the sub-streams, partially storing one or more sub-streams for sequenced combination with other sub-streams, and playing the formed rich media.

30. A system to receive rich media over a digital network, the system comprising:
a digital network; and
a client in communication with the digital network, the client comprising
a request module configured to request receipt of two or more sub-streams over the digital network, each sub-stream requested from a different address, the sub-streams comprising digital packet data suitable for transport over Internet Protocol (“IP”) networks and are combined with synchronizing information, the synchronizing information comprising sequence information added to the digital packets of each sub-stream, wherein digital packets of the two or more sub-streams that correspond to a point in play each include a sequence identifier indicating the point in play;
a receiver module configured to receive the sub-streams; and
a combining module configured to combine the sub-streams to form the rich media based on the synchronizing information contained in the sub-streams, the rich media comprising at least one of video data and audio data.

31. The system of claim 30, wherein the client further comprises an interactive layer module configured to receive an interactive layer, the interactive layer synchronized to one or more of the sub-streams and corresponding to the rich media from which the sub-streams were processed.

32. The system of claim 30, wherein the interactive layer module is further configured to receive replacement sub-stream data and to combine the replacement sub-stream data with a sub-stream to form a corrected sub-stream in response to detecting that a sub-stream is missing data or has incorrect data.

33. The system of claim 30, further comprising an error correction module configured to correct a sub-stream error using error correction data from a sub-stream.

34. The system of claim 30, wherein the digital network comprises at least one of an Internet Protocol (“IP”) network, a satellite broadcast system, an over-the-air broadcast system, a local area network, a wide area network, a wireless network, and a storage area network.

35. The system of claim 30, wherein the client comprises at least one of a personal computer, a laptop computer, a server, a workstation, a gaming platform, a television, a set-top box, a satellite receiver, a projection system, a Digital Video Disc (“DVD”) player, a video cassette recorder, a video cassette player, a portable audio or video player, a video conferencing system, an audio or video phone, an appliance, a portable communication device, and a digital radio.

36. A system to deliver rich media over a digital network, the system comprising:
a digital network; and
a source computer system in communication with the digital network, the source computer system comprising
a processing module configured to process rich media in two or more sub-streams, the rich media comprising at least one of video content and audio content, the two or more sub-streams comprising digital packets for transport over Internet Protocol (“IP”) networks;
a synchronizing module configured to add synchronizing information to the two or more sub-streams by adding sequence information to the digital packets of each sub-stream, wherein digital packets of the two or more sub-streams that correspond to a point in play each include a sequence identifier indicating the point in play, the synchronizing information sufficient for a client to combine the sub-streams to form the rich media; and
a transmission module configured to transmit the two or more sub-streams concurrently over one or more digital networks to the client for combining the sub-streams to form the rich media, wherein each of the two or more sub-streams is transmitted over a different route, each route corresponding to a unique sub-stream address, and wherein the client requests transmission of the sub-streams from the unique sub-stream addresses.

37. The system of claim 36, further comprising an interactive overlay module configured to create a transparent interactive overlay corresponding to the rich media and synchronized to one or more sub-streams of the rich media.

38. The system of claim 36, further comprising an interactive layer transmission module configured to transmit an interactive layer to the client, the interactive layer comprising at least one of sub-stream address information, sub-stream mapping information, a transparent interactive overlay, and error correction information.

39. The system of claim 38, wherein the interactive layer transmission module further comprises a replacement sub-stream data module configured to transmit replacement sub-stream data via a route communicating the transparent interactive overlay to the client in response to the client determining that sub-stream data is missing or is in error.

40. The system of claim 36, wherein the source computer system comprises at least one of a server, a mainframe computer, a workstation, a personal computer, a laptop computer, a satellite broadcast, a television headend, and a portable communication device.

41. The system of claim 36, further comprising a dynamic casting engine module configured to select at least one of a transmission method, retransmission of sub-streams, transmission timing, and sub-stream content of the sub-streams, wherein selection is based at least one of on client dispersion, demand, and requested content.

42. The system of claim 36, further comprising a repeating system configured to change a transmission of sub-streams transmitted by the transmission module to an alternate transmission with different transmission parameters.
